(19) United States
(12) Patent Application Publication
(10) Pub. No.: US 2001/0022987 A1
(43) Pub. Date: Sep. 20, 2001

(54) Flowable pellets containing nicotinamide and process for the production thereof

(76) Inventors: Martin Korfer, Glattbach (DE); Lutz Rohland, Offenbach (DE); Tobias Dartsch, Frankfurt (DE); Friedel Schultheis, Hasselroth (DE); Hans-Albrecht Hasseberg, Grundau-Lieblos (DE); Bernd Bachmann, Gelnhausen (DE); Gerald Pfaff, Rodenbach (DE)

Correspondence Address: Smith Gambrell & Russell, LLP, Beveridge, DeGrandi, Weilacher & Young, Intellectual Property Group, 1850 M Street, N.W. (Suite 800), Washington, DC, 20036, US

(21) Appl. No.: 09/731,248

(22) Filed: Dec. 7, 2000

(30) Foreign Application Priority Data
Dec. 10, 1999 (DE) 199 59 668.9

(51) Int. Cl. A23K 1/20

(52) U.S. Cl. 426/635; 514/335; 426/89; 426/471; 426/442

(57) ABSTRACT

A process for the production of pellets containing nicotinamide by droplet-processing of molten nicotinamide by means of laminar jet disintegration in a tower and cooling of the molten droplets by heat exchange until solidified spherical particles are formed.

### INTRODUCTION AND BACKGROUND

This present invention relates to flowable pellets containing nicotinamide and to a process for the production of flowable, low-dusting nicotinamide pellets starting from a melt of nicotinamide (NA) with a water content of up to 5 wt. % by droplet-processing in a tower and solidification and cooling of the droplets.

The melt may be provided by various methods. It is accordingly possible to melt a dry, solid product, for example produced according to U.S. Pat. No. 2,471,518, GB 777 517, DE-PS 828 247 or DE-PS 2 131 813, for further use independently of the location at which it was produced and to use it in accordance with the present invention.

It is advantageous to use directly a melt of NA containing only small proportions of impurities produced according to DE OS 25 17 053 and DE-PS 25 17 054 for further processing in accordance with the present invention. These prior documents are relied on and incorporated by reference. This particularly preferred embodiment is considerably simpler to perform and is superior from an energy standpoint. Depending upon the origin of the melt, as a result of the production process it may still contain not only water but also impurities of an organic or inorganic nature. The present invention is used for melts having an NA content in excess of 90 wt. %.

Commercially available products have an elevated purity, sometimes of above 98%, and are distributed as solids. On the basis of segregation behavior, a particle size distribution of 50-1000 μm is suitable for use in feedstuff mixtures. According to DE-OS 25 17 053, the nicotinamide is obtained from a melt by flat solidification on a chilled crystallization belt and establishing the desired grain size range by mechanical processing methods by means of comminution, grinding and screening. Solidification on a chilled crystallization belt according to DE-PS 25 17 054 may also be performed after prior subdivision of the molten phase, for example by atomization or droplet formation. However, the nicotinamide obtained in this manner exhibits handling disadvantages as it may agglomerate on extended storage.

An object of the present invention is to provide a process which, starting from nicotinamide in molten form, gives rise to dust-free, readily flowable, spherical pellets.

### SUMMARY OF THE INVENTION

The nicotinamide melt is produced in known manner by catalytic conversion of β-picoline with atmospheric oxygen and ammonia. The main product, nicotinic acid nitrile, is obtained in the gas phase with elimination of water on the heterogeneous fixed-bed catalyst. Secondary products and unreacted starting materials are separated, isolated and recirculated during recovery. The pure nitrile is saponified, for example according to DE-OS 25 17 053 and DE-PS 25 17 054, by NaOH catalysis to yield the amide, from which the solvent is finally removed, so converting it into the molten state.

The present invention provides flowable pellets containing nicotinamide and a process for the production of very largely spherical particles from a melt of nicotinamide in that the product is produced by subdividing the molten phase through flat jet nozzles or bores of a similar geometry and then cooling the particles so produced by direct heat exchange with a stream of gas in a tower.

### BRIEF DESCRIPTION OF DRAWING

The present invention will be further understood with reference to the accompanying drawing, wherein:

FIG. 1 shows a schematic flow diagram of the process of the invention.

### DETAILED DESCRIPTION OF INVENTION

The advantage of the process of the invention is that pellets may be produced from the melt in a single apparatus, which pellets have the desired dimensions without a dust content and are of spherical shape and thus exhibit excellent flowability.

The liquid phase is subdivided in the liquid phase at water contents of 0 wt. % to 5 wt. %, preferably of 0 wt. % to 0.5 wt. %, particularly preferably of 0 wt. % to 0.1 wt. %, and temperatures of above the melting point to 250° C., in particular of 130° to 170° C. The jets may here be produced using bores of a diameter of 50 μm to 300 μm and admission pressures of 0.1 bar to 20 bar. The cylindrical bore is preferably provided on the inlet side with an inlet section which is favorable to flow. The longitudinal axis of the bore may be oriented as desired; it is preferably aligned downwards parallel to the earth's gravitational field or upwards at an angle of 10°-60°, in particular of 20°-40°, to the perpendicular. The jets of material disintegrate due to instabilities by wavy sheet disintegration, or preferably by laminar jet disintegration.

One particularly advantageous embodiment of this invention consists in exciting the nozzles, nozzle plates used for droplet production, the structure provided for the accommodation thereof or alternatively the melt itself with vibrational energy in the frequency range from 100 Hz to 1 MHz, preferably from 1 kHz to 30 kHz, and using for this purpose vibratable systems based on an interaction of a magnetic and an electric field or alternatively those based on utilizing the piezoelectric effect. This excitation gives rise to a particularly narrow distribution of the droplet size range.

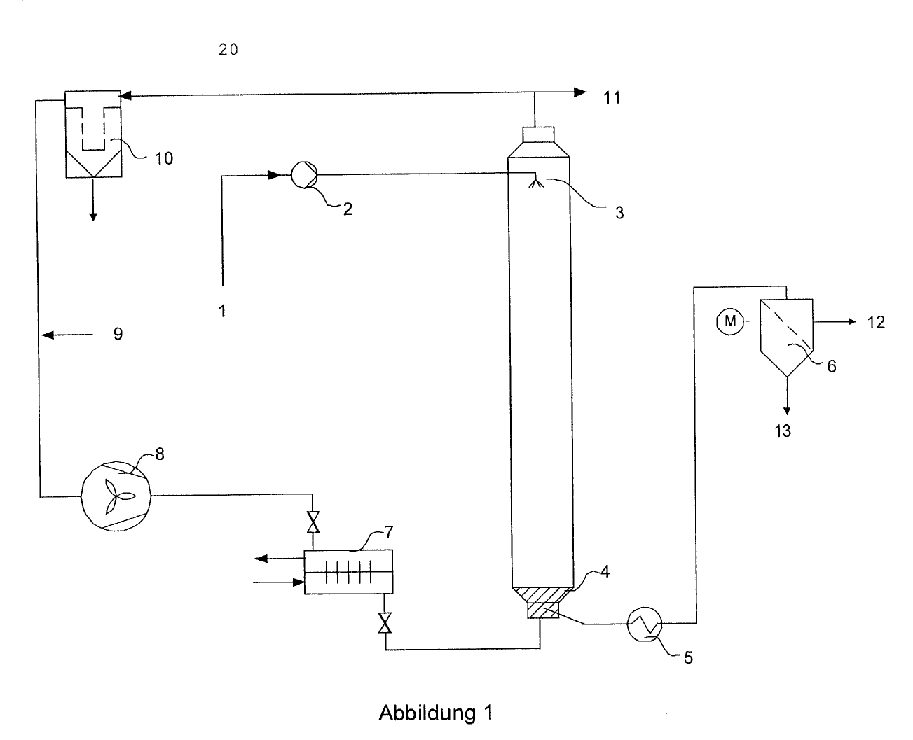

In FIG. 1, the NA melt (1) is fed by a melt pump (2) to a tower apparatus containing a nozzle apparatus (3).

A fluidized bed (4) is provided in the tower. A product cooler (5) is connected to the bottom of the tower from where the product is conveyed to a screen (6) for separating product (13) from oversize material (12). Other features of the apparatus include a circulating gas cooler (7), blower (8), circulating gas feed (9), circulating gas filter (10) and circulating gas vent (11).

Heat is drawn out from the resultant melt droplets by direct heat exchange with a stream of gas until they have solidified and/or cooled. Liquid nitrogen may, for example, be used as the gas for cooling. Alternatively, cooling may also proceed indirectly by cooling water or cold water in an external heat exchanger (see FIG. 1(7)). If the gas and melt droplets are conveyed cocurrently, solidification may be accelerated relative to countercurrent operation.

In another embodiment, the gas is conveyed countercurrently to the droplets and the at least externally solidified droplets are collected at the bottom of the tower in a fluidized bed, which is fluidized by the same stream of gas. The particles in the fluidized bed are preferably the same particles as those which are being produced. Since the fluidized bed provides a residence time for complete solidification and cooling, the drop height may be reduced. The gas is recirculated and cooled by indirect heat exchange with cold water or cooling brine. In this particularly preferred embodiment, mass ratios of gas stream to melt stream of 40:1 to 80:1 are established.

It is furthermore possible to collect the at least externally solidified droplets in a horizontal fluidized bed apparatus, which is subdivided into various zones, so permitting post-drying and/or cooling to be performed therein. The particles produced are discharged as soon as they have achieved their final strength and are optionally passed through a cooler (see FIG. 1(5)), screened and packaged.

The particles are approximately spherical and have a bulk density of >750 kg/m³, preferably of >800 kg/m³, with a particle size distribution between 50 μm and 1000 μm, preferably 150 μm to 700 μm, particularly preferably 200 μm to 600 μm. The particle size fraction <100 μm is generally at most 0.5%, preferably <0.2%.

While nicotinamide which has not been droplet-processed may agglomerate and lose its flowability due to its strongly hygroscopic properties, these properties are not found in the pellets produced according to the invention.

The pellets containing nicotinamide may be further improved or the properties thereof purposefully improved by certain additives. Preferred additives which may be mentioned in this connection are citric acid monohydrate, orthophosphoric acid, magnesium stearate, palmitic acid, dextrin, methacrylate resin (Degalan LP), cellulose acetate, ethylcellulose and sucrose or mixtures of these substances. It has, for example, been found that citric acid and phosphoric acid exert a positive influence upon the handling characteristics of the nicotinamide products treated therewith. This effect preferably occurs at concentrations of between 0.01 wt. % and 5 wt. %, in particular at concentrations of approx. 1 wt. % of additive relative to the nicotinamide.

The low concentration is advantageous, because the highest possible active substance content is desired. The stated additives moreover have a certain nutritive value which means that they not only bring about an improvement in properties but also introduce additional valuable material into the corresponding feedstuff formulations and thus constitute a further advantage.

A comparison of the tendency to agglomerate and angle of repose as a measure of flowability reveals a clear improvement in the nicotinamide pellets in comparison with conventional amorphous nicotinamide, as is shown in Example 5. In the comparison, conventional nicotinamide exhibits the highest angle of repose of 39°. The untreated nicotinamide pellets and those treated with citric acid monohydrate exhibit the lowest angle of repose of 20° and 22° respectively and thus the best flowability (Table 2).

The untreated, conventional nicotinamide exhibits the greatest tendency to agglomerate, stated as a weight in the pressure piston test, of 7.2 kg under extreme climatic conditions or 4.0 kg under standard conditions (Table 2).

The nicotinamide pellets treated with citric acid monohydrate and the untreated nicotinamide pellets exhibited the lowest agglomeration values of 0.9 kg and 1.2 kg respectively. Under standard conditions, the material treated with orthophosphoric acid at only 0.5 kg, and the untreated nicotinamide pellets at 0.6 kg proved the most favorable in comparison with the conventional product.

Qualitative evaluation (Table 3) demonstrates another advantageous effect of the additives.

While untreated pellets containing nicotinamide have a tendency to develop an electrostatic charge on direct contact with plastics packaging, which is manifested qualitatively by a certain degree of adhesion to plastics surfaces, the material treated with orthophosphoric acid or anhydrous citric acid exhibits no surface adhesion. In this manner, pellets containing nicotinamide are provided which have distinctly improved handling characteristics with regard to conventional plastics packaging materials.

The additives may be added both to the nicotinamide melt before the formulation step and to the finished nicotinamide product. Addition may be made both in the form of the pure substances and in the form of a suspension or solution in a suitable solvent.

Application onto the already formed pellets containing nicotinamide is preferably performed directly by introduction in concentrated or dilute form into the fluidized bed, which means that an additional formulation step may be saved. Smaller proportions of additives may moreover be used in the case of introduction into the fluidized bed ranging from 0.05% to 2.5% in comparison with the preferred 0.05% to 5% in the case of introduction into the melt.

As is demonstrated by Comparative Example 6, even with a conventional amorphous grade of nicotinamide, additives reduce the tendency to agglomerate under extreme climatic conditions. Flowability, derived from the angle of repose, tends to be impaired by additives (Table 5). The use of additives in pellets containing nicotinamide consequently appears particularly advantageous.

The invention provides a nicotinamide product which exhibits distinct advantages in comparison with previously available grades, in particular improved flowability, a lower tendency to agglomerate and more stable handling properties.

### EXAMPLE 1

A nicotinamide (NA) melt at a temperature of 145° C. and an admission pressure of 0.4 bar above atmospheric is droplet-processed vertically downwards through a perforated plate with a bore diameter of 200 μm. A mass flow rate of 0.7 kg/h is established. The droplets are collected in liquid nitrogen, solidified and cooled. Sieving reveals that a proportion by weight of 55% is larger than 710 μm, a proportion of 44% is larger than 355 μm and a proportion of 1% is larger than 125 μm. The resultant product is spherical and has excellent flowability.

### EXAMPLE 2

A molten NA jet is produced through a flat jet nozzle with a bore diameter of 200 μm and an admission pressure of 4.0 bar above atmospheric. This melt has an outlet temperature of 160° C. The jet is directed upwards at an angle of 60° to the horizontal and disintegrates at its zenith into droplets which are cooled by countercurrent air in a tower. The drop height is 13 meters. The product is discharged from the fluidized bed at the bottom of the tower at the end of the batch test.

With a total quantity of 5.5 kg,

| | |
|---|---|
| 348 g are in the size range | 125 μm-355 μm |
| 1079 g in the size range | 355 μm-710 μm |
| 3468 g in the size range | 710 μm-1000 μm |
| 640 g in the size range | 1000 μm-1250 μm |

The product is predominantly spherical with slightly flattened portions and also has very good flowability.

### EXAMPLE 3

A NA melt at 170° C. with an admission pressure of 4.5 bar above atmospheric is droplet-processed vertically downwards through flat jet nozzles with a bore diameter of 150 μm in a continuously operated plant without air circulation, in which an upflow velocity of 0.33 m/s is created in the tower. A gas temperature of 14° C. prevails at the nozzle head, the drop height is approx. 20 meters. A product which has very good flowability and a bulk density of at least 790 kg/m³ is continuously discharged from the fluidized bed at the bottom of the tower. 72 wt. % of the granular product is smaller than 630 μm, only 1% is smaller than 200 μm.

### EXAMPLE 4

An NA melt at 150° C. with an admission pressure of 7.9 bar above atmospheric is droplet-processed vertically downwards through flat jet nozzles with a bore diameter of 150 μm in a continuously operated plant with air circulation, the design of which otherwise matches that of Example 3, in which an upflow velocity of 0.40 m/s is created in the tower. At a gas inlet temperature of 10° C., a product is obtained at a dew point of 0° C., 80% of which is smaller than 630 μm and which furthermore contains no particles smaller than 200 μm. Bulk densities of at least 760 kg/m³ are obtained together with very good flowability.

### EXAMPLE 5

Nicotinamide Produced according to Example 4 was surface-Treated with various Additives.

To this end, a weighed quantity was sprayed with solutions of various additives on an ERWEKA pelletizing pan (40 cm diameter) (ERWEKA GmbH, 63130 Heusenstamm, Germany) and the product then dried in a drying cabinet under a water-jet vacuum. The quantities were selected such that the concentration of the additive was 1 wt. % (Table 1).

A comparative product evaluation was then performed relative to the untreated material.

The results are shown in Tables 2 and 3.

Description of product evaluation methods

Bulk density: Measured in measuring cylinder

Angle of repose: A metal sieve (1000 μm) is fixed at a distance of 60 mm above a solid metal cylinder (h=80 mm, D=50 mm). Approx. 50 g of NA are placed in the sieve and slowly pressed through the sieve by hand using a plastic spatula. Powder is passed through the sieve until a geometrically uniformly shaped cone has formed on the cylinder. The height of this cone is measured. The angle of the tested powder may be calculated from the height of the cone (H [mm]) and the diameter of the metal cylinder: Cone angle [°]inv tan

$$\frac{H}{25}$$

H cone height [mm]Total height−80 mm

The angle of repose simulates, for example, the cone in a silo. The smaller is the angle of repose, the better is the flowability.

Tendency to agglomerate: Test under extreme climatic conditions: 40 g of NA are weighed out into a steel cylinder (internal diameter 50 mm), closed with the corresponding core (1.3 kg) onto which is placed a 2 kg weight. This pressure piston is placed in a climate testing cabinet at 40° C. and 92% relative humidity for 24 h. A pressure test rig is then used to measure the force required to destroy the resultant tablet. The lower is the value measured, the lower is the tendency to agglomerate.

Test at room temperature:

Pressure piston as described above, but stored on the laboratory bench at normal room temperature and normal humidity for 12 days.

Visual evaluation/Electrostatic charging: c.f.Table 3

### EXAMPLE 6

Additives with conventional Nicotinamide

A conventional grade of nicotinamide (crystalline powder) (Degussa-Hüls) was surface-treated with various additives in a similar manner to that described in Example 5.

The performance of the testing is shown in Table 4, while the test results are shown in Table 5.

TABLE 1
Performance of Testing

| | | Initial | | | | |
|---|---|---|---|---|---|---|
| | Test | Quantity of | | | Rotational | |
| | no.: | NA [g] | Auxiliary | Spray solution: | speed [rpm] | Performance: |
| NA spheres, | 1 | 400 | none | n/a | n/a | Untreated, overnight |
| untreated | | | | | | drying under water- |
| | | | | | | jet vacuum at 30-40° C. |
| NA spheres | 2 | 400 | H₃PO₄, 85% | 5.1 g pure | 190-250 | DESAGA glass sprayer |
| with 1% | | | | | | with compressed air. |
| orthophospho- | | | | | | Duration 15 min. |
| ric acid | | | | | | Overnight drying |
| | | | | | | under water-jet |
| | | | | | | vacuum at 30-40° C. |
| NA spheres | 3 | 400 | 4 g citric | 4 g citric acid, | 250 | Preval sprayer. |
| with 1% | | | acid, | anhydrous, + 70 | | Duration 45 min. |
| citric acid | | | anhydrous | mL abs. ethanol | | Overnight drying |
| | | | | (clear soln.) | | under water-jet |
| | | | | | | vacuum at 30-40° C. |
| NA spheres | 4 | 400 | 4.4 g citric | 4.4 g citric | 250-300 | DESAGA glass sprayer |
| with 1% | | | acid * H₂O | acid * H₂O in | | with compressed air. |
| citric acid | | | | 300 ml diethyl | | Duration 45 min. |
| monohydrate | | | | ether (somewhat | | Overnight drying |
| | | | | cloudy) | | under water-jet |
| | | | | | | vacuum at 30-40° C. |

Rotational speed [rpm] = rotational speed in revolutions per minute

TABLE 2
Results for Bulk Density, Angle of Repose and Tendency to Agglomerate

| | | | | Tendency to | Tendency to |
|---|---|---|---|---|---|
| | | Bulk | Angle of | Agglomerate, Test under | Agglomerate, Test |
| | | Density | Repose | Extreme climatic | at Room Temperature |
| | Test no.: | [kg/m3] | [°] | conditions (1) [kg] | (2) [kg] |
| NA, conventional, Degussa- | n/a | 609 | 39 | 7.2 | 4.0 |
| Hüls (batch 36980) | | | | | |
| NA spheres, untreated | 1 | 801 | 20 | 1.2 | 0.6 |
| NA spheres with 1% | 2 | 764 | 26 | 2.3 | 0.5 |
| orthophosphoric acid | | | | | |
| NA spheres with 1% citric | 3 | 763 | 28 | 2.4 | 1.6 |
| acid | | | | | |
| NA spheres with 1% citric | 4 | 793 | 22 | 0.9 | 1.3 |
| acid monohydrate | | | | | |

(1) = pressure piston, 40° C., 92% rel. humidity, 24 hours
(2) = pressure piston, room temperature, normal humidity, 12 days

TABLE 3
Results of visual Evaluation, Flowability and Electrostatic charging

| | | Flowability - | |
|---|---|---|---|
| | | Visual Evaluation: | Electrostatic charging - |
| | | Stored for 2 weeks at | Visual Evaluation: |
| | Test | room temperature | 40 g initial weight in PETG |
| | no.: | in sealed, dry glass jar | bottle, 500 ml |
| NA | 1 | Spheres clustered | After shaking, adhesion of a |
| spheres, | | distinctly more tightly | layer of particles to the |
| untreated | | than in Comparative | bottle wall |
| | | Example no. 3 | No adhesion of particles to |
| NA | 2 | Completely flowable | bottle wall. |
| spheres | | | No detectable |
| with 1% | | | electrostatic charging |
| ortho- | | | |
| phos- | | | |
| phoric | | | |
| acid | | | |
| NA | 3 | Spheres somewhat | No adhesion of particles to |
| spheres | | clustered together, | bottle wall. |
| with 1% | | break apart | No detectable |
| citric acid | | immediately on | electrostatic charging |
| | | movement | |
| NA | 4 | Completely flowable | After shaking, adhesion of a |
| spheres | | | layer of particles to the |
| with 1% | | | bottle wall |
| citric acid | | | |
| mono- | | | |
| hydrate | | | |

PETG = polyethylene terephthalate copolyester

TABLE 4
Performance of Testing

| | | Initial | | | Rotational | |
|---|---|---|---|---|---|---|
| | | Quantity | | Spray: | speed | |
| | Test no.: | of NA [g] | Auxiliary | solution: | [rpm] | Performance |
| NA, | 5 | 100 | none | n/a | n/a | Untreated, overnight |
| conventional, | | | | | | drying under water-jet |
| Degussa-Hüls | | | | | | vacuum at 30-40° C. |
| (batch 29762) | | | | | | |
| NA, | 6 | 200 | H₃PO₄, 85% | 2.5 g pure | 190 | DESAGA glass sprayer |
| conventional, | | | | | | with compressed air. |
| with 1% | | | | | | Duration 15 min. |
| orthophosphoric | | | | | | Overnight drying under |
| acid | | | | | | water-jet vacuum at |
| | | | | | | 30-40 ° C. |
| NA, | 7 | 100 | Citric acid, | 1 g citric | 200-400 | Preval sprayer, slow |
| conventional, | | | anhydrous | acid, | | spraying. Duration 120 |
| with 1% citric | | | | anhydrous, + | | min. Overnight drying |
| acid | | | | 50 mL abs. | | under water-jet vacuum |
| | | | | ethanol | | at 30-40° C. |
| | | | | (clear | | |
| | | | | soln.) | | |

TABLE 5
Results: Tendency to Agglomerate

| | | Tendency to | |
|---|---|---|---|
| | | Agglomerate: Test under | Angle |
| | Test | Extreme climatic | of repose |
| Batch | no.: | conditions (1) [kg] | [°] |
| NA, conventional, | 5 | 5.0 | 33.0 |
| Degussa-Hüls | | | |
| (batch 29762) | | | |
| NA, conventional, with 1% | 6 | 2.1 | 36.0 |
| orthophosphoric acid | | | |
| NA, conventional, with 1% | 7 | 2.2 | 37.0 |
| citric acid | | | |

(1) = pressure piston, 40° C., 92% rel. humidity, 24 hours

Further modifications and variations of the foregoing will be apparent to those skilled in the art and are intended to be encompassed by the claims appended hereto.

German priority application 199 59 668.9 is relied on and incorporated herein by reference.

We claim:

1. Flowable pellets containing nicotinamide with a spherical shape, a bulk density of >750 kg/m³, a particle size distribution from 50 to 1000 μm, a dust content of <0.5% and optionally an additive content of 0.01 to 5 wt. % and a nicotinamide content of at least 90 wt. %.

2. Flowable pellets containing nicotinamide according to claim 1, wherein said additive is a member selected from the group consisting of orthophosphoric acid, citric acid monohydrate, magnesium stearate, palmitic acid, cellulose acetate, ethylcellulose, methacrylate resin, sucrose, dextrin and mixtures thereof.

3. Flowable pellets containing nicotinamide according to claim 2, wherein said additive has been sprayed onto the pellet surface at a content of 0.05 to 5 wt. % as a solution, suspension or melt.

4. A process for the production of flowable pellets containing nicotinamide with a particle size distribution from 50 to 1000 μm and a water content of up to 5 wt. %, comprising conveying a melt of nicotinamide at temperatures between the melting point and 250° C. to a tower, spraying said melt in said tower to form molten droptlets, cooling the molten droplets by direct heat exchange with gas until solidified pellets are formed.

5. The process according to claim 4, wherein the droplets are formed in the tower by laminar jet disintegration or wavy sheet disintegration of a nicotinamide melt jet, wherein the liquid jet is produced by outflow from bores with a diameter between 50 μm and 300 μm under a delivery pressure of between 0.1 bar and 20 bar.

6. The process according to claim 4, wherein the droplets are cooled cocurrently with the gas until solidified granular product may be discharged from the tower at its bottom and a mass ratio of gas:nicotinamide of 20:1 to 60:1 is established for this purpose.

7. The process according to claim 4,wherein the droplets are cooled countercurrently to the gas and are collected from the tower and its bottom in a fluidized bed of the same produced particles fluidized by the same gas and a mass ratio of gas:nicotinamide of 40:1 to 80:1 is established for this purpose.

8. The process according to claim 4, wherein, once solidified, the pellets are further cooled to a silo temperature.

9. The process according to claim 4, wherein said gas for cooling is nitrogen.

10. The process according to claim 4 wherein nozzle apparatus is used to spray said melt and are subjected to vibrational energy.

11. An animal feedstuff containing the nicotinamide pellets according to claim 1.

12. An animal feedstuff containing the nicotinamide pellets according to claim 2.
